(19) United States
(12) Patent Application Publication
(10) Pub. No.: US 2026/0307881 A1
(43) Pub. Date: Oct. 8, 2026

(54) INSULATED AND HEATED GLOVE BAG FOR POWERLINE WORKERS

(71) Applicant: Robert Smith, Brockton, MA (US)

(72) Inventor: Robert Smith, Brockton, MA (US)

(21) Appl. No.: 19/098,284

(22) Filed: Apr. 2, 2025

(51) Int. Cl. B65D 81/18; A45F 5/00; A45F 5/02; B65D 81/38; B65D 85/18; G05D 23/19; H05B 1/02; H05B 3/34

(52) U.S. Cl. CPC B65D 81/18; A45F 5/021; B65D 81/3897; B65D 85/18; G05D 23/1917; H05B 1/0275; H05B 3/342; A45F 2005/002

(57) ABSTRACT

The present disclosure relates to an insulated and heated glove bag designed for powerline workers. The glove bag features a major compartment that houses a pair of rubber gloves and a minor compartment that contains a rechargeable battery. The major compartment is equipped with a series of small heating elements sewn into the fabric, which are connected to the rechargeable battery. Additionally, the major compartment includes a temperature sensor. The temperature sensor and heating elements can be wirelessly linked to a smartphone, allowing the user to adjust the operation of the heating elements, monitor the glove bag's real-time temperature, and perform other related functions through a mobile application. The glove bag also features a two-layer insulation system, with an inner layer made of army blanket wool and an outer layer of bubble insulation. The opening of the major compartment is secured with a Velcro lining to further enhance its insulation.

### TECHNICAL FIELD

The present disclosure relates to the fields of electrical engineering and safety equipment.

### BACKGROUND

Rubber gloves are critical safety equipment for high-voltage utility and powerline workers, typically stored in a glove bag when not in use. While working on high-voltage power lines, lineworkers usually attach their glove bags to the bucket (truck) using a clip to securely fasten them.

Lineworkers frequently encounter challenging and sometimes even extreme weather conditions, such as frigid temperatures or storms, while on the job. Rubber gloves get cold quickly in these conditions. Hence, a lineworker's hands may become cold and numb, impairing their ability to perform tasks effectively. The discomfort from the cold can also reduce focus and concentration. Even worse, prolonged exposure to low temperatures may lead to long-term health issues, such as carpal tunnel syndrome and arthritis.

To address this issue, lineworkers typically keep a spare pair of rubber gloves in the truck, warming them on the truck's heater. When their gloves become too cold, they may return to the truck to retrieve the spare pair. However, this process can disrupt their workflow and hinder efficiency—an essential factor in challenging weather conditions, as communities rely on lineworkers to restore power quickly and minimize disruptions to daily life. In extreme situations, lineworkers may not have access to a truck at all, as they may need to climb poles to restore power.

The presently disclosed technology aims to address these challenges by providing an insulated and heated glove bag for lineworkers, designed to keep rubber gloves warm in harsh weather conditions.

### SUMMARY

The presently disclosed technology teaches an insulated and heated glove bag, comprising: a plurality of walls forming a major compartment and a minor compartment; wherein, the plurality of walls is made of insulating material; wherein, the major compartment has a first sealable opening; wherein, the major compartment houses a pair of rubber gloves; wherein, the minor compartment includes one or more rechargeable batteries; wherein, the major compartment includes a plurality of heating elements and a temperature sensor; wherein, the plurality of heating elements is sewn to the plurality of walls; wherein, the heating elements are connected to and powered by the one or more rechargeable batteries.

In some embodiments, the first sealable opening is sealed by a Velcro lining.

In some embodiments, the Velcro lining is attached to the first sealable opening by one or more rivets.

In some embodiments, the plurality of walls has an inner layer made of army blanket wool and an outer layer made of bubble insulation.

In some embodiments, the plurality of walls has an outermost layer made of canvas.

In some embodiments, the presently disclosed glove bag further comprises a swivel hook attached to the plurality of walls.

In some embodiments, the one or more rechargeable batteries are connected to a charging cable, which passes through a grommet in one of the plurality of walls.

In some embodiments, the grommet is made of rubber.

In some embodiments, an audible alert is triggered in response to a temperature in the major compartment reaching a threshold, as indicated by the temperature sensor.

In some embodiments, the temperature sensor is connected to a smartphone, and the smartphone displays a temperature in the major compartment in real time via a smartphone application.

In some embodiments, the plurality of heating elements is connected to a smartphone; and an operation of the plurality of heating elements can be adjusted via an application on the smartphone.

In some embodiments, the plurality of heating elements can be manually turned on or off via the application on the smartphone.

In some embodiments, a power of operation of the plurality of heating elements can be manually adjusted via the application on the smartphone.

In some embodiments, the temperature sensor is connected to the smartphone; a target temperature can be set via the application; a notification is triggered in response to a temperature in the major compartment reaching the target temperature, measured by the temperature sensor; and the plurality of heating elements is turned off, or a power of operation of the plurality of heating elements is decreased, in response to the notification.

In some embodiments, an estimated time at which the temperature in the major compartment reaches the target temperature is displayed via the application.

In some embodiments, the temperature sensor is connected to the smartphone; a signal is triggered in response to a temperature in the major compartment dropping below a threshold temperature, as measured by the temperature sensor; the plurality of heating elements is turned on, or a power of operation of the plurality of heating elements is increased in response to the signal.

In some embodiments, an estimated time before which the rubber gloves can stay at or above a desired temperature is displayed via the application.

In some embodiments, the first sealable opening is covered by a flap-style lid.

In some embodiments, the presently disclosed glove bag further comprises the pair of rubber gloves.

In some embodiments, the heating elements are connected to the rechargeable batteries via one or more USB or USB-C connectors.

### BRIEF DESCRIPTION OF THE DRAWINGS

The present disclosure is further illustrated by way of exemplary embodiments, which are described in detail through the accompanying drawings. These embodiments are not limiting, and in these embodiments, the same numbering indicates the same structure, wherein:

FIG. 1 is an isometric diagram of an insulated and heated glove bag for powerline workers, according to some embodiments of the present disclosure.

FIG. 2 is another isometric diagram of the insulated and heated glove bag for powerline workers, according to some embodiments of the present disclosure.

FIG. 3 is an isometric back-view diagram of the insulated and heated glove bag for powerline workers, according to some embodiments of the present disclosure.

### DETAILED DESCRIPTION

In order to more clearly illustrate the technical solutions of the embodiments of the present disclosure, the accompanying drawings for the description of the embodiments are described below. Obviously, the accompanying drawings in the following description are only some examples or embodiments of the present disclosure, and it is possible for a person of ordinary skill in the art to apply the present disclosure to other similar scenarios in accordance with these accompanying drawings without creative labor. Unless obviously obtained from the context or the context illustrates otherwise, the same numeral in the drawings refers to the same structure or operation.

It should be understood that the terms “system,” “device,” “unit,” and/or “module” are used herein as a way to distinguish between different components, elements, parts, sections, or assemblies at different levels. However, if other words may achieve the same purpose, the terms may be replaced with alternative expressions.

As indicated in the present disclosure and in the claims, unless the context clearly suggests an exception, the words “one,” “a,” “a kind of,” and/or “the” do not refer specifically to the singular but may also include the plural. In general, the terms “include” and “comprise” suggest only the inclusion of clearly identified steps and elements, which do not constitute an exclusive list, and the method or device may also include other steps or elements.

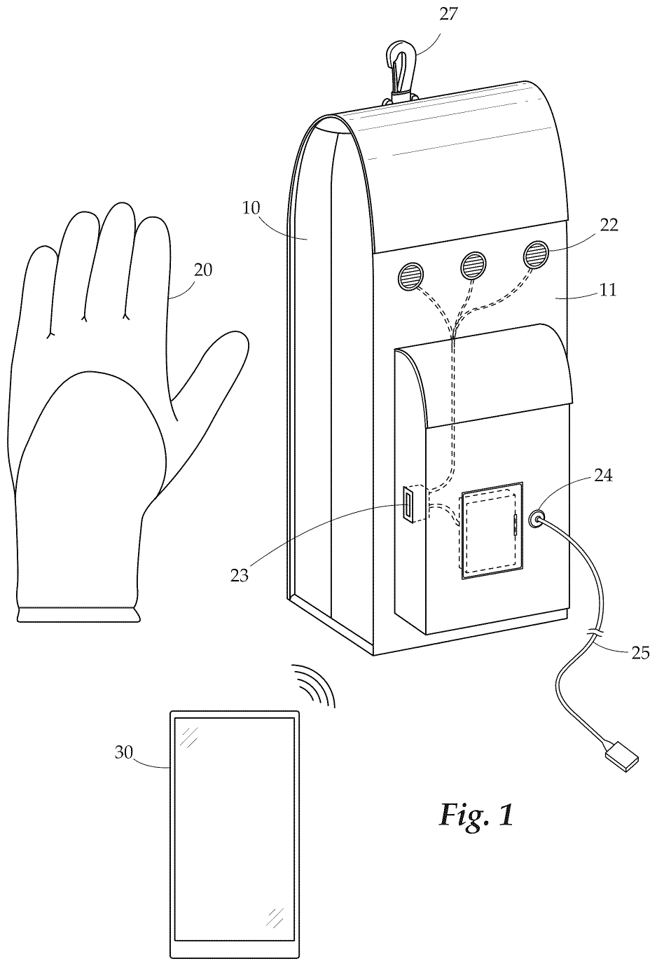

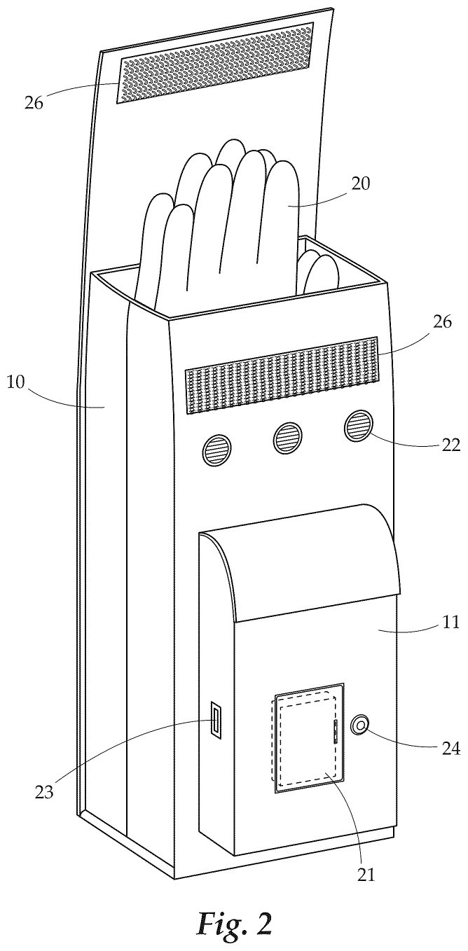

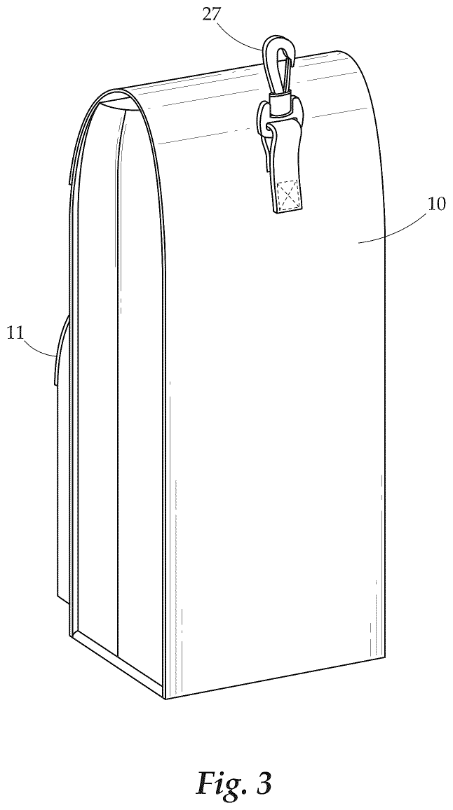

FIGS. 1-2 are isometric diagrams of an insulated and heated glove bag for powerline workers, according to some embodiments of the present disclosure; FIG. 3 is an isometric back-view diagram thereof.

The insulated and heated glove bag (the “glove bag”) may include one or more compartments. In some embodiments, the glove bag features a major compartment 10 designed to hold a pair of rubber gloves 20, and a minor compartment 11 for one or more batteries 21. The minor compartment 11 is smaller than the major compartment 10. In some embodiments, the one or more batteries 21 may be removed from the minor compartment 11 for recharging or replacement. In some embodiments, one or more batteries 21 may be rechargeable and can be connected to a power outlet via a cable 25. The cable 25 may pass through a grommet 24, which may be made of rubber or other materials with similar properties to ensure it is non-conductive and weatherproof.

In some embodiments, the major compartment 10 may accommodate more than one pair of rubber gloves 20. Additionally, the glove bag may include multiple major compartments 10, allowing for the storage of multiple pairs of rubber gloves 20, and/or other components, appliances, tools, or items. In some embodiments, the glove bag may omit a minor compartment 11, with one or more batteries 21 instead placed within the major compartment 10, housed in an inner bag within the major compartment, or integrated into the fabric of the glove bag.

Each compartment may feature an opening, which can be sealed with a Velcro lining 26 to improve insulation. The Velcro lining 26 may be sufficiently wide to cover all or a significant portion of the opening, thereby enhancing insulation. While zippers can also provide an airtight seal, Velcro offers easier opening and closing. In some embodiments, the Velcro lining 26 is secured to the glove bag with one or more rivets 31, allowing for easy replacement when it becomes worn. In other embodiments, the Velcro lining 26 may be used alongside one or more rivets 31, to further secure the opening.

In some embodiments, the opening may be covered by a flap-style lid 29, which may further enhance the insulation of the glove bag.

In some embodiments, alternatively, the major compartment 10 may feature an opening, but the minor compartment 11 may not feature an opening.

In some embodiments, the glove bag may feature a two-layer insulation system, with an inner layer made of army blanket wool and an outer layer composed of bubble insulation. Alternatively, the glove bag may include one or more layers of wool or bubble insulation, but not both. The layers of wool and/or bubble insulation may also be arranged in other orders. The glove bag may also incorporate other insulating materials, such as thermal fleece, closed-cell foam, reflective insulation, down or synthetic down, aluminum foil, Mylar, or cotton. To enhance durability, the glove bag may have an outermost layer of canvas or be placed in an outer bag made of canvas. The canvas may be substituted with other durable materials, such as denim, ripstop nylon, coated polyester, leather, ballistic nylon, or hemp fabric. The outer bag may include one or more layers of wool, bubble insulation, or other types of insulation as previously discussed. Alternatively, an inner bag may be placed inside the major compartment 10 to hold the gloves 20. This inner bag can be permanently or semi-permanently inserted to enhance insulation properties. Like the outer bag, the inner bag may also incorporate one or more layers of wool, bubble insulation, or other insulation materials as described above.

In some embodiments, the glove bag may feature a swivel hook 27 for detachably securing the bag to a bucket (the truck on which the user works). The swivel hook 27 may, for example, attach to a B-hook on the bucket. The swivel hook 27 may also be attached to a belt or climbing harness if the lineworker has no access to the truck. Alternatively, the swivel hook 27 may be replaced by a carabiner, spring hook, snap hook, magnetic clasp, or other suitable fasteners. The swivel hook 27, or other types of connectors, may be further attached to a strap. For example, in one embodiment, the swivel hook 27 may be replaced by a heavy-duty leather strap to which a carabiner is attached. In some embodiments, the glove bag may be integrated into a jacket, tool bag, or other types of clothing, bags, or storage containers. In some embodiments, as illustrated in FIGS. 1-3, the swivel hook 27 may be positioned at the central upper portion of the glove bag's back.

In some embodiments, the glove bag may include one or more heating elements 22 to keep the rubber gloves 20 warm. These heating elements 22 may be sewn into the fabric defining the major compartment 10. Examples of suitable heating elements 22 include wire heating elements, PTC (positive temperature coefficient) heating elements, carbon fiber heating elements, flexible silicone rubber heating pads, flexible heating films or pads, metallic film heating elements, and others. In some embodiments, the heating elements 22 may be relatively small (e.g., with a diameter of less than ⅓ inch) and distributed approximately evenly across the entirety or a portion of the fabric forming the major compartment 10. In some embodiments, the heating elements 22 may be removable from the fabric for replacement or repair.

In some embodiments, the heating elements 22 may be controlled via a controller accessible from a control panel. In certain embodiments, the controller may be a computerized device, such as a smartphone, while the control panel may be implemented as a smartphone application 30. For example, a user may operate the smartphone application 30 on their personal device to turn the heating elements on or off or adjust their power levels.

In some embodiments, the major compartment 10 may include a temperature sensor 28 to monitor the internal temperature. When the temperature reaches a target level, the sensor 28 may trigger an alert, such as an audible signal, a smartphone notification, or an LED light activation on the glove bag, indicating that the rubber gloves 20 are properly heated and ready for use. Upon detecting this signal, the controller may also adjust the heating elements 22 by modifying their power output or turning them off as needed. Similarly, if the temperature drops below a predetermined threshold, the sensor 28 may notify the controller, which will then activate or increase the heat output of the heating elements 22.

In some embodiments, the target temperature and the predetermined threshold may be set or adjusted through the control panel 30, which, as mentioned earlier, may be implemented as a smartphone app. As discussed above, the user may also manually adjust the operation of the heating elements 22 through the control panel 30, such as turning the heating elements on or off, or adjusting the power of operation of the heating elements.

In some embodiments, the heating elements 22 may be connected to one or more batteries 21 using USB or USB-C cables.

As discussed above, the presently disclosed technology may include a controller and a control panel 30. In some embodiments, the controller may be a computerized device, such as a smartphone, wirelessly connected to the glove bag, with the control panel 30 implemented as a smartphone application. Through the control panel, the user may set a target temperature for the major compartment 10 to reach, monitor the glove bag's real-time temperature, and manually adjust the operation of the heating elements.

Additionally, the control panel 30 may display other relevant information, such as the current temperature, the current weather conditions, weather forecast, an estimated time for the rubber gloves 20 to reach the target temperature, and an estimated time before which the rubber gloves can retain the desired warmth (stay at or above the threshold temperature).

Alternatively, the controller may be implemented as a microcontroller embedded within the glove bag or as a separate device. Instead of being implemented as a smartphone app, the control panel 30 may incorporate one or more touchscreens, LED displays, indicator lights, buttons, toggles, or switches. For example, the user could activate or deactivate the heating elements 22 using a toggle on the glove bag. Additionally, when the major compartment 10 reaches the target temperature, as detected by the temperature sensor 28, an LED indicator on the glove bag may light up. The control panel 30, in whole or in parts, may either be integrated into the glove bag or function as a standalone device.

Furthermore, unless explicitly stated in the claims, the use of order, numbers, letters, or other names for processing elements and sequences are not intended to limit the order of the processes and methods of the present disclosure. While various examples have been discussed in the disclosure as currently considered useful embodiments of the invention, it should be understood that such details are provided for illustrative purposes only. The appended claims are not limited to the disclosed embodiments, and instead, the claims are intended to cover all modifications and equivalent combinations within the scope and essence of the embodiments disclosed in the present disclosure. For example, although the described system components may be implemented through a hardware device, they may also be realized solely through a software solution, such as installing the described system on an existing processing or mobile device.

Similarly, it should be noted that, for the sake of simplifying the presentation of embodiments disclosed in the present disclosure and aiding in understanding one or more embodiments of the present disclosure, various features have been sometimes combined into a single embodiment, drawing, or description. However, this manner of disclosure does not imply that the features required by the claims are more than the features mentioned in the claims. In fact, the features of the embodiments are less than all the features of the single embodiment disclosed in the foregoing disclosure.

In some embodiments, numeric values describing the composition and quantity of attributes are used in the description. It should be understood that such numeric values used for describing embodiments may be modified with qualifying terms such as “about,” “approximately” or “generally”. Unless otherwise stated, “about,” “approximately” or “generally” indicates that a variation of ±20% is permitted in the described numbers. Accordingly, in some embodiments, the numerical parameters used in the disclosure and claims are approximations, which can change depending on the desired characteristics of the individual embodiment. In some embodiments, the numerical parameters should take into account a specified number of valid digits and employ a general manner of bit retention. Although the numerical ranges and parameters used in some embodiments of the present disclosure to confirm the breadth of the range are approximations, in specific embodiments, such numerical values are set as precisely as practicable.

With respect to each of the patents, patent applications, publications of patent applications, and other material, such as articles, books, specifications, publications, documents and the like, cited in the present disclosure, the entire contents thereof are hereby incorporated herein by reference. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terminology in the materials appended to the present disclosure and the contents described herein, the descriptions, definitions, and/or use of terminology in the present disclosure shall prevail.

In closing, it should be understood that the embodiments described in the present disclosure are used only to illustrate the principles of the embodiments of the present disclosure. Other deformations may also fall within the scope of the present disclosure. Therefore, by way of example and not limitation, alternative configurations of the embodiments disclosed in the present disclosure may be considered consistent with the teachings of the present disclosure. Accordingly, the embodiments described in the present disclosure are not limited to the explicitly introduced and described embodiments in the present disclosure.

What is claimed is:

1. An insulated and heated glove bag, comprising:
a plurality of walls forming a major compartment and a minor compartment;
wherein, the plurality of walls is made of insulating material;
wherein, the major compartment has a first sealable opening;
wherein, the major compartment houses a pair of rubber gloves;
wherein, the minor compartment includes one or more rechargeable batteries;
wherein, the major compartment includes a plurality of heating elements and a temperature sensor;
wherein, the plurality of heating elements is sewn to the plurality of walls;
wherein, the heating elements are connected to and powered by the one or more rechargeable batteries.

2. The insulated and heated glove bag of claim 1, wherein the first sealable opening is sealed by a Velcro lining.

3. The insulated and heated glove bag of claim 2, wherein the Velcro lining is attached to the first sealable opening by one or more rivets.

4. The insulated and heated glove bag of claim 1, wherein the plurality of walls has an inner layer made of army blanket wool and an outer layer made of bubble insulation.

5. The insulated and heated glove bag of claim 1, wherein the plurality of walls has an outermost layer made of canvas.

6. The insulated and heated glove bag of claim 1, further comprising a swivel hook attached to the plurality of walls.

7. The insulated and heated glove bag of claim 1, wherein the one or more rechargeable batteries are connected to a charging cable, which passes through a grommet in one of the plurality of walls.

8. The insulated and heated glove bag of claim 7, wherein the grommet is made of rubber.

9. The insulated and heated glove bag of claim 1, wherein an audible alert is triggered in response to a temperature in the major compartment reaching a threshold, as indicated by the temperature sensor.

10. The insulated and heated glove bag of claim 1,
wherein the temperature sensor is connected to a smartphone,
wherein the smartphone displays a temperature in the major compartment in real time via a smartphone application.

11. The insulated and heated glove bag of claim 1,
wherein the plurality of heating elements is connected to a smartphone;
wherein an operation of the plurality of heating elements can be adjusted via an application on the smartphone.

12. The insulated and heated glove bag of claim 11,
wherein the plurality of heating elements can be manually turned on or off via the application on the smartphone.

13. The insulation and heated glove bag of claim 11,
wherein a power of operation of the plurality of heating elements can be manually adjusted via the application on the smartphone.

14. The insulation and heated glove bag of claim 11,
wherein the temperature sensor is connected to the smartphone;
wherein a target temperature can be set via the application;
wherein a notification is triggered in response to a temperature in the major compartment reaching the target temperature, measured by the temperature sensor;
wherein the plurality of heating elements is turned off, or a power of operation of the plurality of heating elements is decreased, in response to the notification.

15. The insulation and heated glove bag of claim 14,
wherein an estimated time at which the temperature in the major compartment reaches the target temperature is displayed via the application.

16. The insulation and heated glove bag of claim 11,
wherein the temperature sensor is connected to the smartphone;
wherein a signal is triggered in response to a temperature in the major compartment dropping below a threshold temperature, as measured by the temperature sensor;
wherein the plurality of heating elements is turned on, or a power of operation of the plurality of heating elements is increased in response to the signal.

17. The insulation and heated glove bag of claim 11, wherein an estimated time before which the rubber gloves can stay at or above a desired temperature is displayed via the application.

18. The insulation and heated glove bag of claim 1, wherein the first sealable opening is covered by a flap-style lid.

19. The insulation and heated glove bag of claim 1, further comprising the pair of rubber gloves.

20. The insulation and heated glove bag of claim 1, wherein the heating elements are connected to the rechargeable batteries via one or more USB or USB-C connectors.
